(19) United States
(12) Patent Application Publication
(10) Pub. No.: US 2010/0054378 A1
(43) Pub. Date: Mar. 4, 2010

(54) CENTER FREQUENCY ADJUSTMENT DEVICE AND RELATED METHOD FOR A COMMUNICATIONS RECEIVER

(76) Inventors: Kun-Chien Hung, Hsin-Chu City (TW); Ying-Yao Lin, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 12/330,518

(22) Filed: Dec. 9, 2008

(30) Foreign Application Priority Data
Sep. 3, 2008 (TW) 097133718

(51) Int. Cl. H04L 27/16

(52) U.S. Cl. 375/344

(57) ABSTRACT

A center frequency adjustment device for a communications receiver includes an A/D converter coupled to an analog filter in the communications receiver for converting an output signal of the analog filter to a digital signal, a carrier frequency offset estimator coupled to the A/D converter for estimating a carrier frequency offset of the communications receiver according to the digital signal, and a control circuit coupled to the analog filter and the carrier frequency offset estimator for adjusting a center frequency of the analog filter according to the carrier frequency offset.

### BACKGROUND OF THE INVENTION

1. Field of the Invention

The present invention relates to a center frequency adjustment device and related method for a communications receiver, and more particularly, to a center frequency adjustment device and related method for adjusting a center frequency of an analog filter in a communications receiver according a receiving signal of the communications receiver.

2. Description of the Prior Art

A communication system uses a frequency modulation process to raise the signal spectrum of a message signal to be transmitted over a carrier to a frequency that can be radiated efficiently with an antenna. When a communications receiver receives a signal transmitted by a communications transmitter, the communications receiver has to demodulate the received signal to obtain the message signal. The communications receiver may use a carrier generated by a local oscillator different from the carrier used by the communications transmitter to demodulate the received signal, which results in so-called carrier frequency offset. As a result of carrier frequency offset, there is a difference between the original message signal and the demodulated message signal.

In a carrier frequency offset environment, an analog filter in the communications receiver would distort the received signal. Besides, due to some uncertainties in the manufacturing process of the analog filter, the filter characteristics, e.g. center frequency and bandwidth, may diverge from default values. In order to solve this problem, U.S. Pat. No. 5,179,727 discloses an automatic adjusting circuit for an analog filter, as shown in FIG. 1. In FIG. 1, an automatic adjusting circuit 10 includes analog filters 100 and 102 with different selectivities and phase detectors 104 and 106, and generates a bias input signal Sb fed back to the analog filters 100 and 102 and to an analog filter 14. The automatic adjusting circuit 10 is utilized for making a center frequency “fo” of the analog filter 14 equal to a reference frequency “fs” of an input signal SI of the automatic adjusting circuit 10. Therefore, the automatic adjusting circuit 10 can be used to calibrate the deviation between the realistic value and the theoretic value of the center frequency of the analog filter 14.

However, the conventional automatic adjusting circuit 10 can only adjust the center frequency deviation resulted from the manufacturing process and cannot match the center frequency of the analog filter with characteristics of the received signal.

### SUMMARY OF THE INVENTION

It is therefore a primary objective of the claimed invention to provide a center frequency adjustment device and related method for a communications receiver.

The present invention discloses a center frequency adjustment device for a communications receiver. The center frequency adjustment device comprises an A/D converter coupled to an analog filter in the communications receiver for converting an output signal of the analog filter to a digital signal, a carrier frequency offset estimator coupled to the A/D converter for estimating a carrier frequency offset of the communications receiver according to the digital signal, and a control circuit coupled to the analog filter and the carrier frequency offset estimator for adjusting a center frequency of the analog filter according to the carrier frequency offset.

The present invention further discloses a communications receiver comprising an antenna for receiving an input signal, an analog filter coupled to the antenna for filtering the input signal to generate an output signal, a signal processing device for decoding a digital signal, and a center frequency adjustment device coupled to the analog filter and the signal processing device. The center frequency adjustment device comprises an A/D converter coupled to the analog filter for converting the output signal to the digital signal, a carrier frequency offset estimator coupled to the A/D converter for estimating a carrier frequency offset of the communications receiver according to the digital signal, and a control circuit coupled to the analog filter and the carrier frequency offset estimator for adjusting a center frequency of the analog filter according to the carrier frequency offset.

The present invention further discloses a center frequency adjustment method for an analog filter in a communications receiver. The center frequency adjustment method comprises converting an output signal of the analog filter to a digital signal, estimating a carrier frequency offset of the communications receiver according to the digital signal, and adjusting a center frequency of the analog filter according to the carrier frequency offset.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an automatic adjusting circuit for an analog filter according to the prior art.

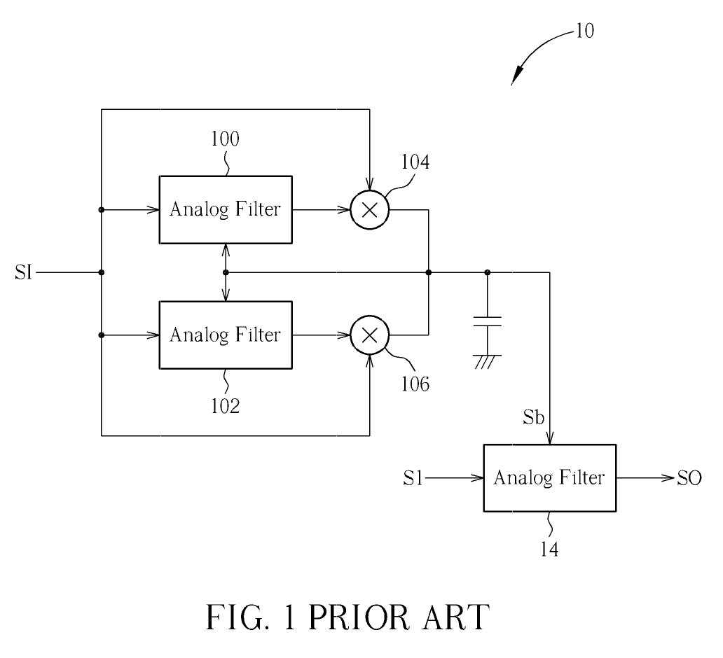

FIG. 2 is a schematic diagram of a center frequency adjustment device according to an embodiment of the present invention.

FIG. 3 is a flowchart of a center frequency adjustment process according to an embodiment of the present invention.

FIG. 4 is a schematic diagram of a communications receiver according to an embodiment of the present invention.

### DETAILED DESCRIPTION

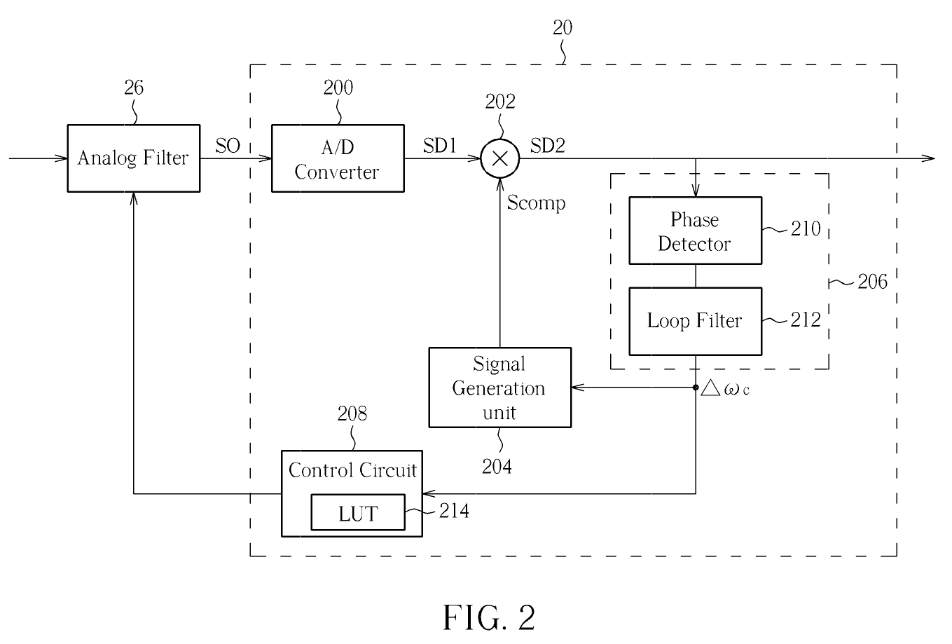

Please refer to FIG. 2, which is schematic diagram of a center frequency adjustment device 20 used in a communications receiver according to an embodiment of the present invention. The center frequency adjustment device 20 is utilized for adjusting a center frequency of an analog filter 26 in the communications receiver according to a received signal in order to make the center frequency of the analog filter 26 match with characteristics of the received signal. The analog filter 26 is utilized for filtering the received signal to generate an output signal SO.

The center frequency adjustment device 20 comprises an analog to digital (A/D) converter 200, a mixer 202, a signal generation unit 204, a carrier frequency offset estimator 206 and a control circuit 208. The A/D converter 200 is coupled to the analog filter 26 and is utilized for converting the output signal SO generated by the analog filter 26 to a digital signal SD1. The embodiment uses the A/D converter 200 to translate the received signal so that a center frequency of the analog filter 26 can be adjusted by a digital signal process. A closed loop is formed by the mixer 202, the signal generation unit 204 and the carrier frequency offset estimator 206. The mixer 202 is coupled to the A/D converter 200 and is utilized for mixing the digital signal SD1 with a compensation signal S_{comp} in order to compensate a phase offset of the digital signal SD1 and generate a digital signal SD2 accordingly. The carrier frequency offset estimator 206 is coupled to the mixer 202 and is utilized for estimating a carrier frequency offset Δω_{c} of the communications receiver according to the digital signal SD2. The signal generation unit 204 is coupled to the mixer 202 and the carrier frequency offset estimator 206, and is utilized for generating the compensation signal S_{comp} sent to the mixer 202 according to the carrier frequency offset Δω_{c}. The control circuit 208 is coupled to the analog filter 26 and the carrier frequency offset estimator 206, and is utilized for adjusting the center frequency of the analog filter 26 according to the carrier frequency offset Δω_{c}.

In FIG. 2, the carrier frequency offset estimator 206 comprises a phase detector 210 and a loop filter 212. The phase detector 210 is coupled to the mixer 202 and is utilized for estimating the phase offset of the digital signal SD2. The loop filter 212 is coupled to the phase detector 210, and is utilized for generating the carrier frequency offset Δω_{c} according to the phase offset of the digital signal SD2. Operations of the phase detector 210 and the loop filter 212 are known by those skilled in the art and are not given here. Please note that, the carrier frequency offset estimator 206 in FIG. 2 is one of embodiments of the present invention, and functions of the carrier frequency offset estimator 206 can be implemented by other circuits and components. The control circuit 208 comprises a look-up table (LUT) 214 for storing a plurality of calibration parameters. The control circuit 208 selects a proper calibration parameter from the plurality of calibration parameters according to the carrier frequency offset Δω_{c} for adjusting the center frequency of the analog filter 26. Size of the LUT 214 and an adjustable range for the center frequency of the analog filter 26 are designed depending on requirements.

Briefly, the center frequency adjustment device 20 converts the output signal SO to the digital signal SD1, estimates the phase offset of the digital signal SD2 and generates the carrier frequency offset Δω_{c}. Next, the center frequency adjustment device 20 adjusts the center frequency of the analog filter 26 according to the carrier frequency offset Δω_{c}, and at the same time, generates the compensation signal S_{comp} according to the carrier frequency offset Δω_{c} for compensating the phase offset of the digital signal SD1.

Note that, the center frequency adjustment device 20 is one of embodiments of the present invention, and those skilled in the art can make alterations and modifications accordingly. For example, another embodiment of the center frequency adjustment device 20 does not comprise the mixer 202 and the signal generation unit 204. In this situation, the carrier frequency offset estimator 206 estimates the carrier frequency offset Δω_{c} according to the digital signal SD1 and does not compensate the phase offset of the digital signal SD1.

As mentioned previously, the conventional automatic adjusting circuit can only adjust a center frequency of an analog filter in a communications receiver to compensate center frequency deviation resulted from the manufacturing process and cannot adjust the center frequency according to the received signal. In comparison, the present invention adjusts the center frequency of the analog filter 26 according to the output signal SO (which is taken as the received signal for the communications receiver). Consequently, the analog filter 26 after the center frequency adjustment is matched with characteristics of the received signal, so that the analog filter 26 does not distort the received signal.

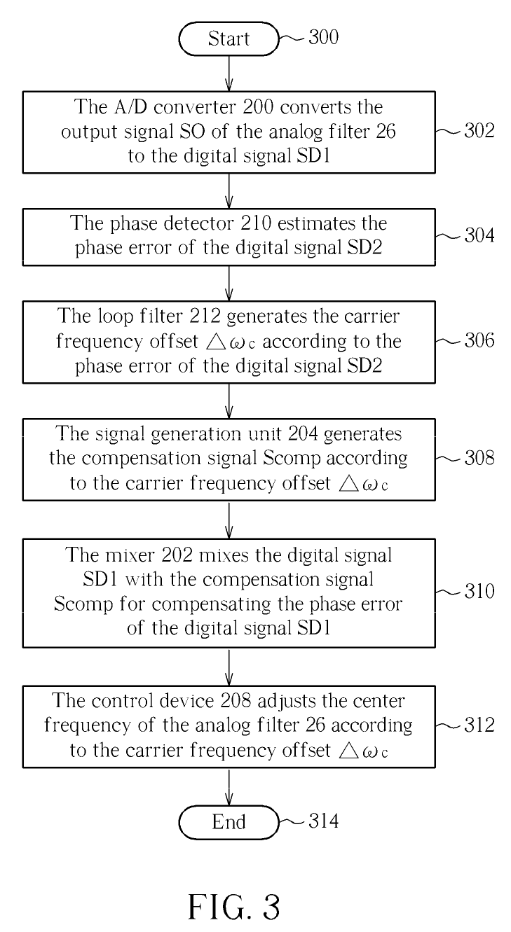

Please refer to FIG. 3, which is a flowchart of a center frequency adjustment process 30 according to an embodiment of the present invention. The center frequency adjustment process 30 is used in the center frequency adjustment device 20 and comprises the following steps:

Step 300: Start.

Step 302: The A/D converter 200 converts the output signal SO of the analog filter 26 to the digital signal SD1.

Step 304: The phase detector 210 estimates the phase offset of the digital signal SD2.

Step 306: The loop filter 212 generates the carrier frequency offset Δω_{c} according to the phase offset of the digital signal SD2.

Step 308: The signal generation unit 204 generates the compensation signal S_{comp} according to the carrier frequency offset Δω_{c}.

Step 310: The mixer 202 mixes the digital signal SD1 with the compensation signal S_{comp} for compensating the phase offset of the digital signal SD1.

Step 312: The control circuit 208 adjusts the center frequency of the analog filter 26 according to the carrier frequency offset Δω_{c}.

Step 314: End.

Please note that, Step 304 and Step 306 can be combined into one step: the carrier frequency offset estimator 206 estimates the carrier frequency offset Δω_{c} according to the digital signal SD2 because the phase detector 210 and the loop filter 212 are included in the carrier frequency offset estimator 206. In addition, Step 308 and Step 310 may be ignored in another embodiment because the mixer 202 and the signal generation unit 204 are optional. According to the center frequency adjustment process 30, the center frequency adjustment device 20 can adjust the center frequency of the analog filter 26 to match with characteristics of the received signal so the analog filter 26 does not distort the received signal.

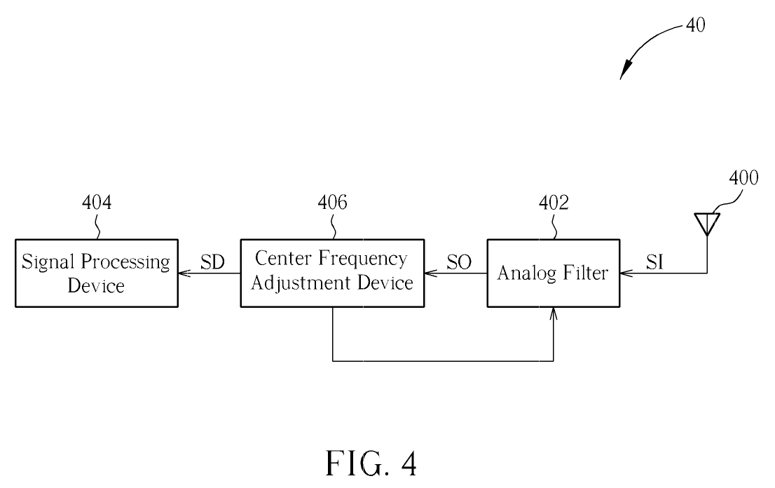

Please refer to FIG. 4, which is schematic diagram of a communications receiver 40 according to an embodiment of the present invention. The communications receiver 40 comprises an antenna 400, an analog filter 402, a signal processing device 404 and a center frequency adjustment device 406. The antenna 400 is utilized for receiving an input signal SI. The analog filter 402 is coupled to the antenna 400 and is utilized for filtering the input signal SI to generate an output signal SO. The center frequency adjustment device 406 is coupled to the analog filter 402 and the signal processing device 404, and is utilized for adjusting the center frequency of the analog filter 402 according to the output signal SO for matching the center frequency of the analog filter 402 with characteristics of the input signal SI received by the antenna 400. The center frequency adjustment device 406 is equal to the center frequency adjustment device 20 in FIG. 2, which is described previously and is not repeated here. The center frequency adjustment device 406 comprises an A/D converter so the center frequency adjustment device 406 can convert the output signal SO to a digital signal SD. The signal processing device 404 performs a decoding process on the digital signal SD to obtain the correct message signal to be transmitted. From the above, by the center frequency adjustment device 406, the center frequency of the analog filter 402 is matched with characteristics of the received signal so that the received signal is not distorted by the analog filter 402.

In conclusion, the embodiment of the present invention estimates the carrier frequency offset of the received signal of a communications receiver and then adjusts the center frequency of the analog filter accordingly. As a result, the center frequency of the analog filter is matched with characteristics of the received signal so that signal distortion is improved.

Those skilled in the art will readily observe that numerous modifications and alterations of the device and method may be made while retaining the teachings of the invention.

What is claimed is:

1. A center frequency adjustment device for a communications receiver, the center frequency adjustment device comprising:
an A/D converter coupled to an analog filter in the communications receiver for converting an output signal of the analog filter to a digital signal;
a carrier frequency offset estimator coupled to the A/D converter for estimating a carrier frequency offset of the communications receiver according to the digital signal; and
a control circuit coupled to the analog filter and the carrier frequency offset estimator for adjusting a center frequency of the analog filter according to the carrier frequency offset.

2. The center frequency adjustment device of claim 1 further comprising a mixer coupled to the A/D converter and the carrier frequency offset estimator for mixing the digital signal with a compensation signal, for compensating a phase offset of the digital signal.

3. The center frequency adjustment device of claim 2 further comprising a signal generation unit coupled to the carrier frequency offset estimator and the mixer for generating the compensation signal according to the carrier frequency offset.

4. The center frequency adjustment device of claim 1, wherein the carrier frequency offset estimator comprises:
a phase detector for estimating a phase offset of the digital signal; and
a loop filter coupled to the phase detector for generating the carrier frequency offset according the phase offset.

5. The center frequency adjustment device of claim 1, wherein the control circuit comprises a look-up table for storing a calibration parameter corresponding to the carrier frequency offset, for adjusting the center frequency of the analog filter.

6. The center frequency adjustment device of claim 5, wherein the look-up table comprises a plurality of calibration parameters.

7. A communications receiver comprising:
an antenna for receiving an input signal;
an analog filter coupled to the antenna for filtering the input signal to generate an output signal;
a signal processing device for decoding a digital signal; and
a center frequency adjustment device coupled to the analog filter and the signal processing device, the center frequency adjustment device comprising:
an A/D converter coupled to the analog filter for converting the output signal to the digital signal;
a carrier frequency offset estimator coupled to the A/D converter for estimating a carrier frequency offset of the communications receiver according to the digital signal; and
a control circuit coupled to the analog filter and the carrier frequency offset estimator for adjusting a center frequency of the analog filter according to the carrier frequency offset.

8. The communications receiver of claim 7, wherein the center frequency adjustment device further comprises a mixer coupled to the A/D converter and the carrier frequency offset estimator for mixing the digital signal with a compensation signal, for compensating a phase offset of the digital signal.

9. The communications receiver of claim 8, wherein the center frequency adjustment device further comprises a signal generation unit coupled to the carrier frequency offset estimator and the mixer for generating the compensation signal according to the carrier frequency offset.

10. The communications receiver of claim 7, wherein the carrier frequency offset estimator comprises:
a phase detector for estimating a phase offset of the digital signal; and
a loop filter coupled to the phase detector for generating the carrier frequency offset according the phase offset.

11. The communications receiver of claim 7, wherein the control circuit comprises a look-up table for storing a calibration parameter corresponding to the carrier frequency offset, for adjusting the center frequency of the analog filter.

12. The communications receiver of claim 11, wherein the look-up table comprises a plurality of calibration parameters.

13. A center frequency adjustment method for an analog filter in a communications receiver, the center frequency adjustment method comprising:
converting an output signal of the analog filter to a digital signal;
estimating a carrier frequency offset of the communications receiver according to the digital signal; and
adjusting a center frequency of the analog filter according to the carrier frequency offset.

14. The center frequency adjustment method of claim 13 further comprising:
mixing the digital signal with a compensation signal for compensating a phase offset of the digital signal.

15. The center frequency adjustment method of claim 14 further comprising:
generating the compensation signal according to the carrier frequency offset.

16. The center frequency adjustment method of claim 13, wherein the step of estimating the carrier frequency offset of the communications receiver comprises:
estimating a phase offset of the digital signal; and
generating the carrier frequency offset according the phase offset.

17. The center frequency adjustment method of claim 13, wherein the step of adjusting the center frequency of the analog filter according to the carrier frequency offset comprises:
selecting a calibration parameter corresponding to the carrier frequency offset from a look-up table, for adjusting the center frequency of the analog filter.

18. The center frequency adjustment method of claim 17, wherein the look-up table comprises a plurality of calibration parameters.
